(19) United States
(12) Patent Application Publication
(10) Pub. No.: US 2024/0184611 A1
(43) Pub. Date: Jun. 6, 2024

(54) VIRTUAL BASEBOARD MANAGEMENT CONTROLLER CAPABILITY VIA GUEST FIRMWARE LAYER

(71) Applicant: Microsoft Technology Licensing, LLC, Redmond, WA (US)

(72) Inventors: Jin LIN, Seattle, WA (US); David Alan HEPKIN, Redmond, WA (US); Michael Bishop EBERSOL, Woodinville, WA (US); Trevor Mark JONES, Santa Rosa, CA (US); Daniel Gil PRILIK, Seattle, WA (US)

(21) Appl. No.: 18/075,291

(22) Filed: Dec. 5, 2022

(51) Int. Cl. G06F 9/455; G06F 11/34

(52) U.S. Cl. CPC G06F 9/45558; G06F 11/3409; G06F 2009/45575; G06F 2009/45587

(57) ABSTRACT

Virtual baseboard management controller capability to monitor and manage a virtual machine (VM). A guest firmware is operated within a first guest privilege context of a guest partition operating as a VM. The guest partition also includes a second guest privilege context that is restricted from accessing memory associated with the first guest privilege context, and that operates a guest operating system. The guest firmware establishes a communications channel between the first guest privilege context and a client device, and receives a request for performance of a management operation against the VM. The guest firmware initiates the management operation, which includes changing a power state of the VM; stopping or restarting the guest OS; presenting a graphical or serial console associated with the guest OS; updating a firmware associated with the guest partition; or managing a virtual device presented by the first guest privilege context.

### BACKGROUND

Hypervisor-based virtualization technologies allocate portions of a computer system's physical resources (e.g., processor cores and/or time, physical memory regions, storage resources) into separate partitions, and execute software within each of those partitions. Hypervisor-based virtualization technologies therefore facilitate creation of virtual machines (VMs) that each executes guest software, such as an operating system (OS) and applications executing therein. A computer system that hosts VMs is commonly called a VM host or a VM host node. While hypervisor-based virtualization technologies can take a variety forms, many use an architecture comprising a hypervisor that has direct access to hardware and that operates in a separate execution environment than all other software in the system, a host partition that executes a host OS and host virtualization stack, and one or more guest partitions corresponding to VMs. The host virtualization stack within the host partition manages guest partitions, and thus the hypervisor grants the host partition a greater level of access to the hypervisor, and to hardware resources, than it does to guest partitions.

Taking HYPER-V from MICROSOFT CORPORATION as one example, the HYPER-V hypervisor is the lowest layer of a HYPER-V stack. The HYPER-V hypervisor provides basic functionality for dispatching and executing virtual processors for VMs. The HYPER-V hypervisor takes ownership of hardware virtualization capabilities (e.g., second-level address translation (SLAT) processor extensions such as rapid virtualization indexing (RVI) from ADVANCED MICRO DEVICES (AMD), or extended page tables (EPT) from INTEL; an input/output (I/O) memory management unit (IOMMU) that connects a direct memory access (DMA)-capable I/O bus to main memory; processor virtualization controls). The HYPER-V hypervisor also provides a set of interfaces to allow a HYPER-V host stack within a host partition to leverage these virtualization capabilities to manage VMs. The HYPER-V host stack provides general functionality for VM virtualization (e.g., memory management, VM lifecycle management, device virtualization).

In addition to isolating guest partitions from each other, some hypervisor-based virtualization technologies further operate to isolate VM state (e.g. processor registers, memory) from the host partition and a host OS executing therein, and in some cases also from the hypervisor itself. Many of these technologies can also isolate VM state from an entity (e.g., a virtualization service provider) that manages a VM host. To achieve the foregoing, these virtualization technologies introduce a security boundary between at least the hypervisor and the host virtualization stack. This security boundary restricts which VM resources can be accessed by the host OS (and, in turn, which VM resources can be accessed by the host virtualization stack) to ensure the integrity and confidentiality of a VM's data (e.g., processor register state, memory state). Such a VM is referred to herein as a confidential VM (CVM). Examples of hardware-based technologies that enable CVMs include hardware-based technologies such as software guard extensions (SGX) from INTEL or secure encrypted virtualization secure nested paging (SEV-SNP) from AMD. Software-based CVMs are also possible.

Additionally, for physical computer systems, a baseboard management controller (BMC) is a microcontroller (e.g., embedded on the computer system's motherboard) that operates independently of a computer system's central processing unit (CPU) and an OS executing thereon. Among other things, a BMC typically provides capabilities to monitor the computer system's hardware via sensors, to flash the computer system's BIOS/UEFI firmware, to give remote console access (e.g., via serial access; or via virtual keyboard, video, mouse), to power cycle the computer system, and to log events.

The subject matter claimed herein is not limited to embodiments that solve any disadvantages or that operate only in environments such as those described above. Rather, this background is only provided to illustrate one example technology area where some embodiments described herein may be practiced.

### BRIEF SUMMARY

In some aspects, the techniques described herein relate to a method, implemented at a computer system that includes a processor, for providing a virtual machine (VM) management capability via guest firmware, the method including: operating a guest firmware within a first guest privilege context of a guest partition operating as a VM, the guest partition also including a second guest privilege context that is restricted from accessing memory associated with the first guest privilege context, and that is configured to operate a guest operating system (OS); and at the guest firmware, establishing a communications channel between the first guest privilege context and a client device; receiving, over the communications channel, a request for performance of a management operation against the VM; and based on the request, initiating the management operation, including at least one of: changing a power state of the VM; stopping or restarting the guest OS; presenting a serial console associated with the guest OS; presenting a graphical console associated with the guest OS; updating a firmware associated with the guest partition; or managing a virtual device presented by the first guest privilege context.

In some aspects, the techniques described herein relate to a computer system, including: a processing system; and a computer storage media that stores computer-executable instructions that are executable by the processing system to at least: operate a guest firmware within a first guest privilege context of a guest partition operating as a VM, the guest partition also including a second guest privilege context that is restricted from accessing memory associated with the first guest privilege context, and that is configured to operate a guest OS; and at the guest firmware, establish a communications channel between the first guest privilege context and a client device; receive, over the communications channel, a request for performance of a management operation against the VM; and based on the request, initiate the management operation, including at least one of: change a power state of the VM; stop or restart the guest OS; present a serial console associated with the guest OS; present a graphical console associated with the guest OS; update a firmware associated with the guest partition; or managing a virtual device presented by the first guest privilege context.

In some aspects, the techniques described herein relate to a computer program product including a computer storage media that stores computer-executable instructions that are executable by a processing system to at least: operate a guest firmware within a first guest privilege context of a guest partition operating as a VM, the guest partition also including a second guest privilege context that is restricted from accessing memory associated with the first guest privilege context, and that is configured to operate a guest OS; and at the guest firmware, establish a communications channel between the first guest privilege context and a client device; receive, over the communications channel, a request for performance of a management operation against the VM; and based on the request, initiate the management operation, including at least one of: change a power state of the VM; stop or restart the guest OS; present a serial console associated with the guest OS; present a graphical console associated with the guest OS; update a firmware associated with the guest partition; or managing a virtual device presented by the first guest privilege context.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the advantages and features of the systems and methods described herein can be obtained, a more particular description of the embodiments briefly described above will be rendered by reference to specific embodiments thereof which are illustrated in the appended drawings. Understanding that these drawings depict only typical embodiments of the systems and methods described herein, and are not therefore to be considered to be limiting of their scope, certain systems and methods will be described and explained with additional specificity and detail through the use of the accompanying drawings in which:

FIG. 1 illustrates an example computer architecture that facilitates providing a virtual baseboard management controller capability via guest firmware;

FIG. 2 illustrates an example of a virtual machine (VM) remote management component;

FIG. 3A illustrates an example of a VM remote management component communicating directly with a client device;

FIG. 3B illustrates an example of a VM remote management component communicating with a client device via a host proxy; and

FIG. 4 illustrates a flow chart of an example method for providing a VM management capability via guest firmware.

### DETAILED DESCRIPTION

While virtual machine (VM) hosts can include baseboard management controllers (BMCs) to provide capabilities to monitor and manage the VM hosts themselves, BMCs do not monitor and manage individual VMs operating at a VM host. For example, a VM host's BMC can power cycle the VM host as a whole, but cannot power cycle individual VMs operating thereon. Similarly, a VM host's BMC cannot update VM firmware, provide console access to individual VMs, etc. Instead, virtualization service providers, which provide VM hosting services to a plurality of tenants, have typically provided BMC-like functionality for VMs (e.g., to access a VM's serial console, to power cycle the VM) using software executing within a VM host's host operating system (OS). Such software often takes the form of a VM remote management component of a host virtualization stack which, in turn, executes within a VM host's host OS. A virtualization service provider may expose this BMC-like functionality to tenants via a control plane service (e.g., a web-based service provided by the virtualization service provider, and which enables tenants to deploy, manage, and destroy VMs at VM hosts). When such functionality is accessed at the control plane service for a given VM, the control plane service interacts with the VM remote management component at the VM host corresponding to that VM in order to provide that functionality to the tenant.

Using a host OS (e.g., via a VM remote management component executing thereon) to provide BMC-like functionality has several significant drawbacks. One drawback is that providing this functionality consumes VM host resources (e.g., CPU cycles, memory, network bandwidth) within the context of a host partition, increasing the portion of VM host resources that are used to operate the host OS, and decreasing the portion of VM host resources that are available to guest partitions. This can adversely affect VMs executing at the VM host, including VMs that are not using or benefitting from this functionality. Additionally, consumption of these VM host resources causes additional operating costs for the virtualization service provider, which cannot readily be attributed to individual VMs or tenants.

Another drawback to using a host OS to provide BMC-like functionality is that doing so can open the host OS to instability, security vulnerabilities, and remote attacks. This is because the host OS become susceptible to any implementation bugs, design flaws, protocol vulnerabilities, etc. that exist in the software (e.g., a VM remote management component) that provides this functionality.

Yet another drawback to using a host OS to provide BMC-like functionality is that it inherently brings the host OS into the trusted computing base (TCB) of any VMs that utilize this functionality. While the host OS has traditionally been within a VM's TCB (e.g., because the host OS has access to all of the VM's memory), this is not the case for confidential VMs (CVMs), for which hardware and/or software techniques are used to restrict which VM resources (e.g. processor registers, memory) can be accessed by the host OS. Thus, it may not even be possible to use a host OS to provide BMC-like functionality, while maintaining the restrictions needed to implement a CVM.

The embodiments described herein provide a virtual BMC capability to monitor and manage an individual VM, via a firmware layer that executes within that VM's guest partition. These embodiments create isolated memory contexts within a guest partition, including a lower privilege context and a higher privilege context. Within the lower privilege context, these embodiments execute a guest OS. Within the higher privilege context, these embodiments execute separate software that provides one or more services to the guest OS. Because the software executing in the higher privilege context executes separate from the guest OS, it can be seen as executing transparently “underneath” the guest OS, much like traditional firmware. Thus, this higher privilege context is referred to herein as a guest firmware layer. This guest firmware layer includes a VM remote management component that provides virtual BMC functionality to monitor and manage the VM provided by the guest partition. In embodiments, the virtual BMC functionality includes remote access (e.g., remote serial and/or console access), remote monitoring, firmware updates (e.g., updates to the guest firmware layer, updates to BIOS/UEFI firmware), and the like.

Notably, providing a virtual BMC capability via a firmware layer that executes within a VM's guest partition addresses each of the drawbacks, described supra, of using a host OS to provide BMC-like functionality. For example, because the VM remote management component executes within the context of a guest partition, rather than a host partition, the VM host resources consumed by operation that VM remote management component are attributed to that guest partition, rather than the host partition. This means that the host partition consumes fewer host resources than it would with prior solutions, and any resource overheads associated with use of the VM remote management component are incurred by the VM benefitting from the functionality the VM remote management component is providing (e.g., rather than the host partition, or other VMs). Additionally, operating costs associated with use of the VM remote management component can be attributed to an individual VM and the tenant associated therewith. Thus, the embodiments described herein improve VM host resource management capabilities.

Further, providing a virtual BMC capability via a firmware layer that executes within a VM's guest partition confines any risks (e.g., instability, security vulnerabilities, and remote attacks) associated with execution of the VM remote management component to that guest partition, rather than exposing the host OS to those risks. Thus, the embodiments described herein improve host OS stability and security.

Yet further, providing a virtual BMC capability via a firmware layer that executes within a VM's guest partition enables a CVM to utilize the BMC capability without bringing the host OS into the CVM's TCB (e.g., because the VM remote management component executes within the context of the CVM, rather than the context of the host OS). Thus, the embodiments described herein improve the functionality and security of CVM's.

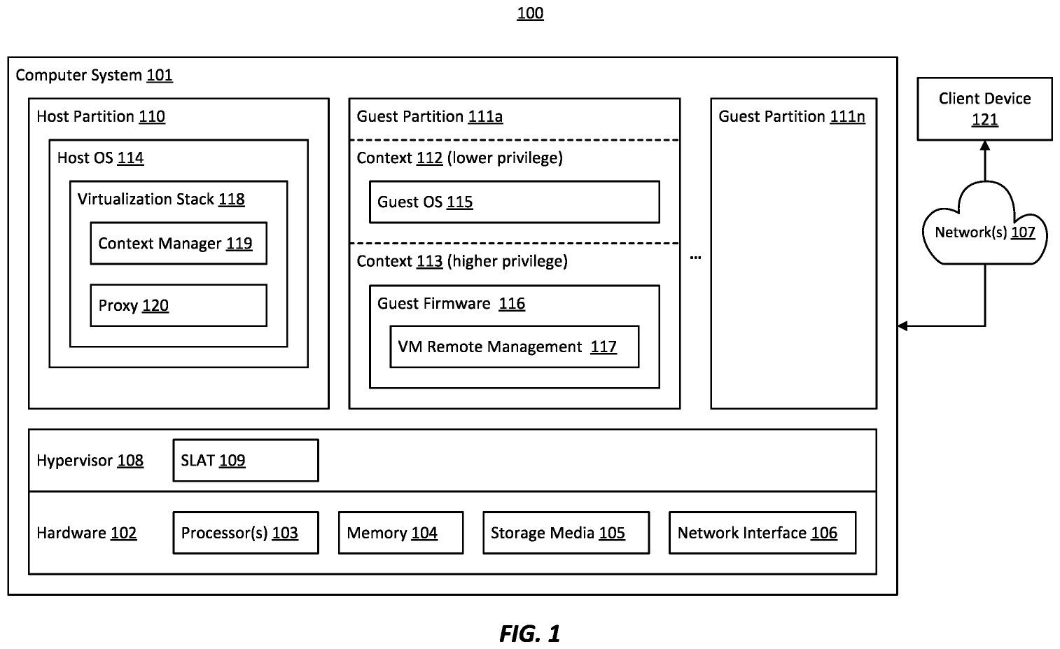

FIG. 1 illustrates an example computer architecture 100 that facilitates providing a virtual BMC capability via guest firmware. As shown, computer architecture 100 includes a computer system 101 comprising hardware 102. Examples of hardware 102 include a processing system comprising processor(s) 103 (e.g., a single processor, or a plurality of processors), memory 104 (e.g., system or main memory), a storage media 105 (e.g., a single computer-readable storage medium, or a plurality of computer-readable storage media), and a network interface 106 (e.g., one or more network interface cards) for interconnecting (via network(s) 107) to one or more other computer systems (e.g., client device 121). Although not shown, hardware 102 may also include other hardware devices, such as a trusted platform module (TPM) for facilitating measured boot features, an input/output (I/O) memory management unit (IOMMU) that connects a direct memory access (DMA)-capable I/O bus to memory 104, a video display interface for connecting to display hardware, a user input interface for connecting to user input devices, an external bus for connecting to external devices, and the like.

As shown, in computer architecture 100, a hypervisor 108 executes directly on hardware 102. In general, hypervisor 108 partitions hardware resources (e.g., processor(s) 103, memory 104, I/O resources) among a host partition 110 within which a host OS 114 executes, as well as a guest partition 111a within which a guest OS 115 executes. As indicated by ellipses, hypervisor 108 may partition hardware resources into a plurality of guest partitions 111 (e.g., guest partition 111a to guest partition 111n) that each executes a corresponding guest OS. In the description herein, the terms “VM” and “guest partition” are used interchangeably, and the term “CVM” is used to indicate when a VM is a confidential VM operating in an isolated guest partition under a CVM architecture. In embodiments, hypervisor 108 also enables regulated communications between partitions via a bus (e.g., a VM Bus, not shown). As shown, host OS 114 includes a virtualization stack 118 which manages VM guest virtualization (e.g., memory management, VM guest lifecycle management, device virtualization) via one or more application program interface (API) calls to hypervisor 108.

In computer architecture 100, virtualization stack 118 is shown as including a context manager 119, which divides a guest partition into different privilege zones, referred to herein as guest privilege contexts. Thus, for example, guest partition 111a is shown as comprising guest privilege context 112 (hereinafter, context 112) and guest privilege context 113 (hereinafter, context 113). In embodiments, context manager 119 can divide any of guest partitions 111 into different guest privilege contexts. In embodiments, context 112 is a lower privilege context (e.g., when compared to context 113), and context 113 is a higher privilege context (e.g., when compared to context 112). In these embodiments, context 112 being lower privilege than context 113 means that context 112 cannot access guest partition memory allocated to context 113. In some embodiments, context 113 can access guest partition memory allocated to context 112. In other embodiments, context 113 lacks access to guest partition memory allocated to context 112.

In some embodiments, context 112 and context 113 are created based on a SLAT 109, which comprises one or more tables that map system physical addresses (SPAs) in memory 104 to guest physical addresses (GPAs) seen by guest partition 111a. In these embodiments, these mappings prevent context 112 from accessing memory allocated to context 113. In one example, hypervisor 108 is the HYPER-V hypervisor and utilizes virtualization-based security (VBS), which uses hardware virtualization features to create and isolate a secure region of memory from an OS, in order to sub-partition guest partition 111a into virtual trust levels (VTLs). In this example, context 113 operates under VBS in a higher privileged VTL (e.g., VTL2), and context 112 operates under VBS in a lower privileged VTL (e.g., VTL1). In other embodiments, context 112 and context 113 are created based on nested virtualization, in which guest partition 111a operates a hypervisor that, similar to hypervisor 108, partitions resources of guest partition 111a into sub-partitions. In these embodiments, this hypervisor operating within guest partition 111a prevents context 112 from accessing memory allocated to context 113.

In embodiments, context 113 executes software (e.g., a kernel, and processes executing thereon) separately from context 112, and provides one or more services to guest OS 115. In some embodiments, software within context 113 executes transparently to guest OS 115, much like firmware. Thus, in embodiments, context 113 operates as a guest firmware layer, as indicated by guest firmware 116. In some embodiments, guest firmware 116 is host compatibility layer (HCL) firmware that provides a set of facilities (e.g., virtualized TPM support, disk encryption, hardware compatibility) to guest OS 115 running within context 112. In embodiments, one of these facilities is a virtual BMC capability.

Guest firmware 116 is illustrated as including a VM remote management component 117. In embodiments, VM remote management component 117 runs within each guest partition that is configured to provide a virtual BMC capability. Because VM remote management component 117 operates within the context of guest partition 111a, in embodiments, VM remote management component 117 is part of guest partition 111a's TCB. Thus, if guest partition 111a operates as a CVM, then VM remote management component 117 is part of that CVM's TCB.

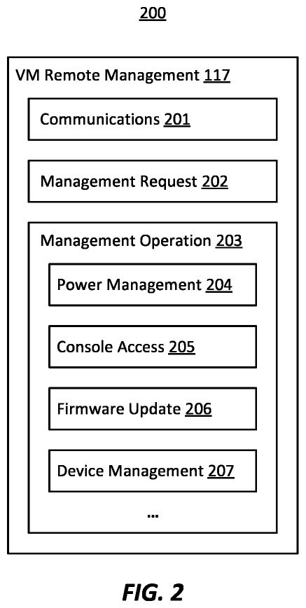

FIG. 2 illustrates an example 200 of internal elements of VM remote management component 117. Each internal element of VM remote management component 117 depicted in FIG. 2 represents various functionalities that VM remote management component 117 might implement in accordance with various embodiments described herein. It will be appreciated, however, that the depicted elements—including their identity and arrangement—are presented merely as an aid in describing example embodiments of VM remote management component 117.

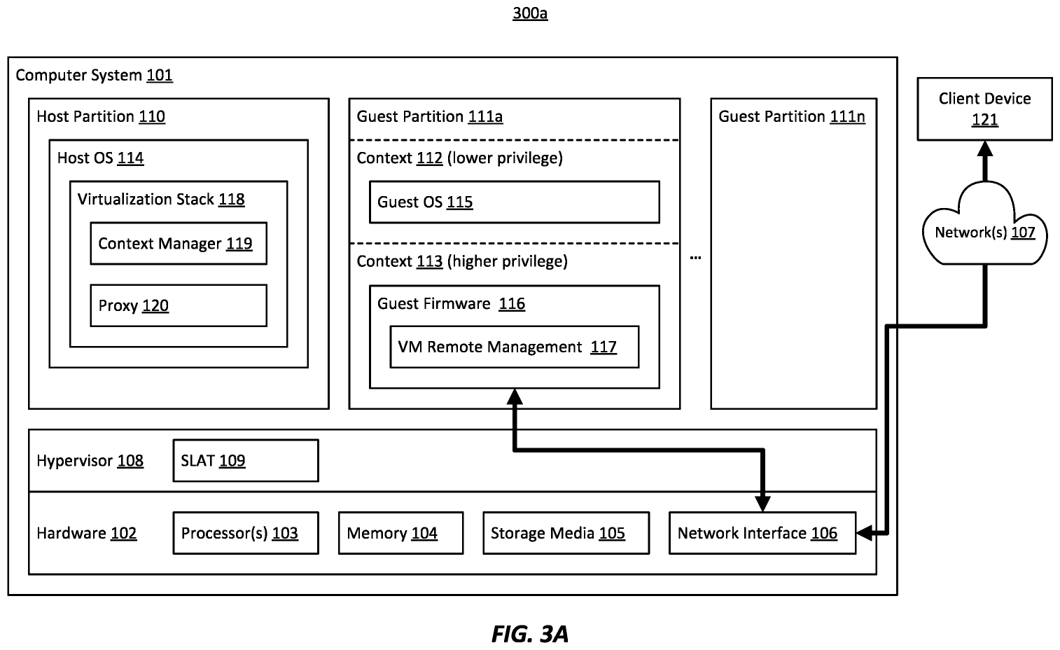

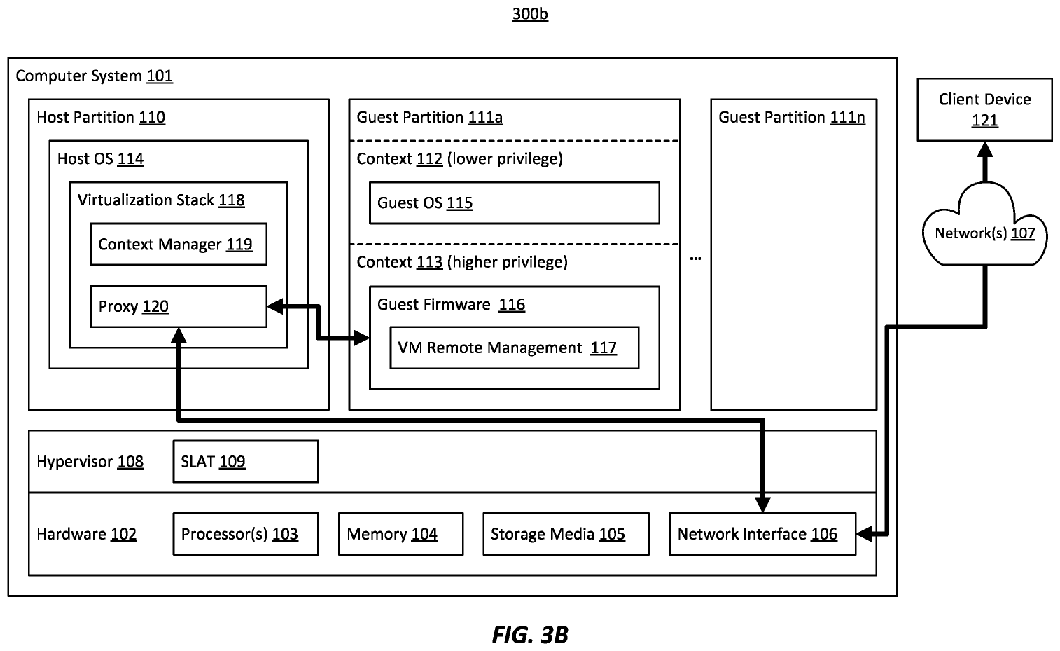

In example 200, VM remote management component 117 includes a communications component 201, which establishes a communications channel (or channels) between guest firmware 116 and a client computing device (e.g., client device 121). In embodiments, a communications channel enables bi-directional communication between VM remote management component 117 and a client computing device. In embodiments, this bi-directional communication is used to provide a client computing device with BMC-like remote monitoring and management of a VM corresponding to guest partition 111a. FIGS. 3A and 3B illustrate examples of communications between a VM remote management component and a client computing device.

FIG. 3A illustrates an example 300a of a VM remote management component communicating directly with a client device. Within the context of computer architecture 100, example 300a uses one heavy arrow to show communications between guest firmware 116 and network interface 106 (e.g., via hypervisor 108), and uses another heavy arrow to show communications between network interface 106 and client device 121 (e.g., via network(s) 107). In embodiments, communications component 201 creates a virtual network interface within context 113 (which, in turn, is exposed by network interface 106), and client device 121 establishes communications channel(s) with guest firmware 116 based on a network address assigned to that virtual network interface. In embodiments, these communications channel(s) utilize the Transmission Control Protocol (TCP), together with an encryption protocol such as Transport Layer Security (TLS). In embodiments, communications component 201 and client device 121 negotiate encryption protocol parameters, including encryption keys.

FIG. 3B illustrates an example 300b of a VM remote management component communicating with a client device via a host proxy. Within the context of computer architecture 100, example 300b uses one heavy arrow to show communications between guest firmware 116 and a proxy component 120 at host partition 110 (e.g., via a VMBus), uses another heavy arrow to show communications between proxy component 120 and network interface 106 (e.g., via hypervisor 108), and uses yet another heavy arrow to show communications between network interface 106 and client device 121 (e.g., via network(s) 107). In embodiments, communications between guest firmware 116 and proxy component 120 are enabled by a socket connection (e.g., HVSOCKET, VSOCK) over a bus, or by an emulated serial connection. In embodiments, a control plane service facilitates establishment of a proxied communications channel between guest firmware 116 and client device 121.

In some embodiments, a communications channel proxied via proxy component 120 is a non-secured channel (e.g., the channel, itself, provides no security guarantees). In these embodiments, much like in example 300a, communications component 201 and guest firmware 116 utilize an encryption protocol, such as TLS, to protect the data communicated therebetween, with communications component 201 and client device 121 negotiating encryption protocol parameters, including encryption keys.

In some embodiments, a communications channel proxied via proxy component 120 is a secured channel (e.g., the channel, itself, provides security guarantees). In these embodiments, proxy component 120 may reside within a secured portion of host partition 110 that is isolated from context 112 (e.g., a VTL running a secure kernel).

Notably, whether VM remote management component 117 communicates directly with client device 121, or via a proxied communications channel, host partition 110 may be able to access memory used by network interface 106 (e.g., due to the network interface's use of DMA). However, because communications component 201 uses encrypted communications, the parameters/keys of which are negotiated by communications component 201 and client device 121, host OS 114 is unable to decipher the data being communicated.

In various embodiments, communications component 201 enables client device connections based on presenting a web page (e.g., by running a web server at context 113), based on presenting a management console (e.g., using the Secure Shell Protocol (SSH)), based on presenting a BMC management API, etc.

In example 200, VM remote management component 117 also includes a management request component 202, which receives a management operation request from a client device (e.g., client device 121) over a communications channel established by communications component 201. Management request component 202 can support a variety of BMC-like operations, such as power management, serial and/or graphical console access, firmware updating, device management, monitoring, logging, and the like. Similarly, VM remote management component 117 also includes a management operation component 203, executes any requested management operation, as received by management request component 202.

As shown, management operation component 203 includes a variety of sub-components corresponding to different types of management operations supported by management operation component 203. In example 200, these include a power management component 204, a console access component 205, a firmware update component 206, and a device management component 207. However, an ellipsis indicates that these management operations are non-exhaustive and that management operation component 203 may support more, or fewer, management operations than those illustrated.

In embodiments, power management component 204 enables power-based controls for a VM. Power-based controls include, as examples, changing a power state of a VM (e.g., “powering off” a VM or resetting the VM), and stopping or restarting a guest OS. In embodiments, changing a power state of a VM comprises stopping and/or starting a virtual processor associated with a guest partition corresponding to the VM. In embodiments, stopping or restarting a guest OS comprises including setting an Advanced Configuration and Power Interface (ACPI) state associated with a VM.

In embodiments, console access component 205 enables serial console access to a VM and/or graphical console access to the VM. In embodiments, console access component 205 creates a virtual console device, which could be a virtual serial console device or a virtual graphical console device, within context 113. Then, console access component 205 routes data received over a communications channel to this virtual console device as an input to the console device (e.g., text representing keyboard input and/or pointing device input), and routes data generated by this virtual console device to the communications channel as an output from the console device (e.g., text data in the case of a serial console, screen data in the case of a graphical console).

In embodiments, firmware update component 206 updates firmware settings and/or updates a firmware image. As examples of updating firmware settings, firmware update component 206 can update settings relating to operation of guest firmware 116, such as configuring settings for a virtual network interface (e.g., a virtual network interface used by communications component 201), configuring encryption settings (e.g., encryption protocol settings, encryption keys), configuring device boot order, enabling/disabling a graphical console, enabling/disabling accelerators, etc. As examples of updating firmware, firmware update component 206 can update guest firmware 116, can update a Basic I/O System (BIOS) firmware used by guest OS 115, can update a Unified Extensible Firmware Interface (UEFI) firmware used by guest OS 115, or can update any other customer-defined firmware (e.g., firmware supporting some virtual hardware device). In an example of updating guest firmware 116, in embodiments firmware update component 206 receives and stages a new firmware image, for installation the next time a VM is restarted.

In embodiments, device management component 207 enables the creation and destruction of virtual hardware devices, such as devices used by context 113 (e.g. a virtual network interface, a virtual console device) or devices that are presented to context 112 (e.g., hardware interfaces, such as for acceleration or compatibility).

As mentioned, management operation component 203 can support a variety of management operations other than those illustrated. Other examples include operations for VM monitoring (e.g., virtual processor monitoring, I/O monitoring), debugging, guest OS boot diagnostics, etc.

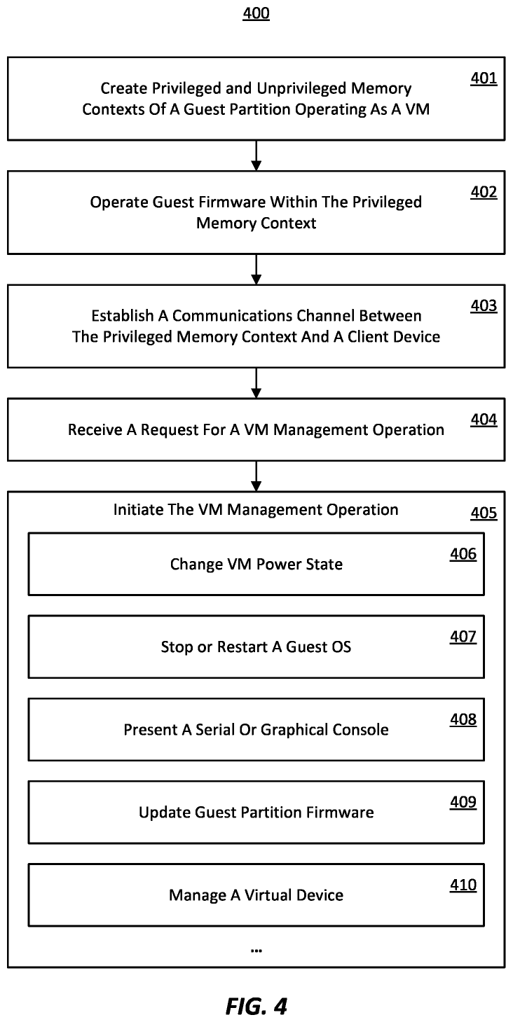

Examples of operation of VM remote management component 117 are now described in connection with FIG. 4, which illustrates a flow chart of an example method 400 for providing a VM management capability via guest firmware (e.g., a guest firmware layer). In embodiments, instructions for implementing method 400 are encoded as computer-executable instructions (e.g., VM remote management component 117) stored on a computer storage media (e.g., storage media 105) that are executable by a processor (e.g., processor(s) 103) to cause a computer system (e.g., computer system 101) to perform method 400.

The following discussion now refers to a number of methods and method acts. Although the method acts may be discussed in certain orders, or may be illustrated in a flow chart as occurring in a particular order, no particular ordering is required unless specifically stated, or required because an act is dependent on another act being completed prior to the act being performed.

Referring to FIG. 4, in embodiments, method 400 comprises an act 401 of creating privileged and unprivileged memory contexts of a guest partition operating as a VM. In some embodiments, act 401 comprises creating a first guest privilege context and a second guest privilege context of a guest partition operating as a VM based on one or more of second-level address translation or nested virtualization, the second guest privilege being restricted from accessing memory associated with the first guest privilege context and being configured to operate a guest OS. In some embodiments of act 401, these contexts are created based on SLAT. In other embodiments of act 401, these contexts are created based on nested virtualization. In an example, context manager 119 partitions guest partition 111a into context 112 and context 113, with context 112 being restricted from accessing memory associated with context 113. This enables guest firmware 116 to operate within context 113 separate from guest OS 115 (which operates context 112). In some embodiments, this means that guest OS 115 is unaware of context 113, and VM remote management component 117 operating therein. Thus, in some embodiments of act 401, that the guest OS is unaware of the first guest privilege context.

In some embodiments, the guest partition is configured as a CVM guest that is isolated from a host partition. In these embodiments, a memory region associated with the guest partition is inaccessible to a host OS.

Referring to FIG. 4, in embodiments, method 400 comprises an act 402 of operating guest firmware within the privileged memory context. In some embodiments, act 402 comprises operating the guest firmware within the first guest privilege context. In an example, guest firmware 116 operates within context 113, such that context 113 is a guest firmware layer. In one example, this guest firmware layer is an HCL. In embodiments, guest firmware 116 is operated within context 113 based on guest firmware 116 having been configured as the initial code that executes when a VM corresponding to guest partition 111a is booted.

Method 400 also comprises an act 403 of establishing a communications channel between the privileged memory context and a client device. In some embodiments, act 403 comprises, at the guest firmware, establishing a communications channel between the first guest privilege context and a client device. In an example, communications component 201 establishes a communications channel with client device 121.

As discussed, in some embodiments, VM remote management component 117 communicates directly with a client device. For example, example 300a demonstrated communications component 201 establishing a communications channel directly with client device 121, based on creating a virtual network adapter at context 113. Thus, in some embodiments of act 403, establishing the communications channel between the first guest privilege context and the client device comprises establishing the communications channel between a virtual network interface created by the guest firmware and the client device.

As discussed, in other embodiments, VM remote management component 117 communicates with a client device via a host proxy. For example, example 300b demonstrated communications component 201 establishing a communications channel indirectly with client device 121, via proxy component 120. Thus, in some embodiments of act 403, establishing the communications channel between the first guest privilege context and the client device comprises establishing the communications channel between the guest firmware and a proxy component operating at a host partition.

In embodiments, an established communications channel is insecure. Thus, the VM remote management component 117 and the client device protect their communications via encryption. This means that, in some embodiments of act 403, establishing the communications channel between the first guest privilege context and the client device comprises negotiating an encryption protocol with the client device.

Method 400 also comprises an act 404 of receiving a request for a VM management operation. In some embodiments, act 404 comprises, at the guest firmware, receiving, over the communications channel, a request for performance of a management operation against the VM. In an example management request component 202 receives, from client device 121, a request for performance of a management operation. As discussed, examples of management operations include power management, serial and/or graphical console access, firmware updating, device management, etc.

Method 400 also comprises an act 405 of initiating the VM management operation. In some embodiments, act 405 comprises, at the guest firmware, and based on the request, initiating the management operation. In an example, based on the request received by management request component 202 in act 404, management operation component 203 carries out that request within the context of the VM associated with guest partition 111a. In FIG. 4, act 405 includes one or more of: an act 406 of changing VM power state, and act 407 of stopping or restarting a guest OS, an act 408 of presenting a serial or graphical console, an act 409 of updating guest partition firmware, or an act 410 of managing a virtual device. Act 406 to act 410 represent example acts that could be carried out, singly or in combination, as part of act 405. An ellipsis indicates that these acts are non-exhaustive and act 404 may support more, or fewer, operations.

In some embodiments, if present, act 406 comprises changing a power state of the VM. In an example, power management component 204 changes a power state of the VM corresponding to guest partition 111a (e.g., “powering off” the VM or resetting the VM). In embodiments, changing the power state of the VM includes at least one of starting a virtual processor associated with the guest partition or stopping the virtual processor.

In some embodiments, if present, act 407 comprises stopping or restarting the guest OS. In an example, power management component 204 stops or restarts guest OS 115. In embodiments stopping or restarting the guest OS includes setting an ACPI state.

In some embodiments, if present, act 408 comprises presenting a serial or graphical console associated with the guest OS. In an example, console access component 205 presents (e.g., to client device 121) outputs of a virtual console device, which can be a virtual serial console device or a virtual graphical console device to the communications channel established in act 403. In some embodiments act 408 comprises presenting a serial console associated with the guest OS, while in other embodiments act 408 comprises presenting a graphical console associated with the guest OS.

In some embodiments, if present, act 409 comprises updating a firmware associated with the guest partition. In an example, firmware update component 206 updates firmware associated with guest partition 111a, which can include updating a firmware setting (e.g., a setting associated with guest firmware 116) and/or updating a firmware image. In embodiments the firmware associated with guest partition 111a is one of: the guest firmware 116; a BIOS firmware used by the guest OS; or a UEFI firmware used by the guest OS.

In some embodiments, if present, act 410 comprises managing a virtual device presented by the first guest privilege context. In an example, device management component 207 creates or destroys a virtual device associated with guest partition 111a. In embodiments, this virtual device is one of: a virtual network interface over which the communications channel is established; a virtual console device over which the graphical or the serial console is presented; or a hardware interface device presented to the second guest privilege context.

Embodiments of the disclosure may comprise or utilize a special-purpose or general-purpose computer system (e.g., computer system 101) that includes computer hardware, such as, for example, a processor system (e.g., processor(s) 103) and system memory (e.g., memory 104), as discussed in greater detail below. Embodiments within the scope of the present disclosure also include physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media (e.g., storage media 105). Computer-readable media that carry computer-executable instructions and/or data structures are transmission media. Thus, by way of example, embodiments of the disclosure can comprise at least two distinctly different kinds of computer-readable media: computer storage media and transmission media.

Computer storage media are physical storage media that store computer-executable instructions and/or data structures. Physical storage media include computer hardware, such as random access memory (RAM), read-only memory (ROM), electrically erasable programmable ROM (EEPROM), solid state drives (SSDs), flash memory, phase-change memory (PCM), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., network interface 106), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

It will be appreciated that the disclosed systems and methods may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. Embodiments of the disclosure may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

It will also be appreciated that the embodiments of the disclosure may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). A cloud computing model can be composed of various characteristics, such as on-demand self-service, broad network access, resource pooling, rapid elasticity, measured service, and so forth. A cloud computing model may also come in the form of various service models such as, for example, Software as a Service (Saas), Platform as a Service (PaaS), and Infrastructure as a Service (laaS). The cloud computing model may also be deployed using different deployment models such as private cloud, community cloud, public cloud, hybrid cloud, and so forth.

Some embodiments, such as a cloud computing environment, may comprise a system that includes one or more hosts that are each capable of running one or more virtual machines. During operation, virtual machines emulate an operational computing system, supporting an operating system and perhaps one or more other applications as well. In some embodiments, each host includes a hypervisor that emulates virtual resources for the virtual machines using physical resources that are abstracted from view of the virtual machines. The hypervisor also provides proper isolation between the virtual machines. Thus, from the perspective of any given virtual machine, the hypervisor provides the illusion that the virtual machine is interfacing with a physical resource, even though the virtual machine only interfaces with the appearance (e.g., a virtual resource) of a physical resource. Examples of physical resources including processing capacity, memory, disk space, network bandwidth, media drives, and so forth.

Although the subject matter has been described in language specific to structural features and/or methodological acts, it is to be understood that the subject matter defined in the appended claims is not necessarily limited to the described features or acts described above, or the order of the acts described above. Rather, the described features and acts are disclosed as example forms of implementing the claims.

The present disclosure may be embodied in other specific forms without departing from its essential characteristics. The described embodiments are to be considered in all respects only as illustrative and not restrictive. All changes which come within the meaning and range of equivalency of the claims are to be embraced within their scope.

When introducing elements in the appended claims, the articles “a,” “an,” “the,” and “said” are intended to mean there are one or more of the elements. The terms “comprising,” “including,” and “having” are intended to be inclusive and mean that there may be additional elements other than the listed elements. Unless otherwise specified, the terms “set,” “superset,” and “subset” are intended to exclude an empty set, and thus “set” is defined as a non-empty set, “superset” is defined as a non-empty superset, and “subset” is defined as a non-empty subset. Unless otherwise specified, the term “subset” excludes the entirety of its superset (i.e., the superset contains at least one item not included in the subset). Unless otherwise specified, a “superset” can include at least one additional element, and a “subset” can exclude at least one element.

What is claimed:

1. A method, implemented at a computer system that includes a processor, for providing a virtual machine (VM) management capability via guest firmware, the method comprising:
operating a guest firmware within a first guest privilege context of a guest partition operating as a VM, the guest partition also including a second guest privilege context that is restricted from accessing memory associated with the first guest privilege context, and that is configured to operate a guest operating system (OS); and
at the guest firmware,
establishing a communications channel between the first guest privilege context and a client device;
receiving, over the communications channel, a request for performance of a management operation against the VM; and
based on the request, initiating the management operation, including at least one of:
changing a power state of the VM;
stopping or restarting the guest OS;
presenting a serial console associated with the guest OS;
presenting a graphical console associated with the guest OS;
updating a firmware associated with the guest partition; or
managing a virtual device presented by the first guest privilege context.

2. The method of claim 1, wherein initiating the management operation includes changing the power state of the VM, including at least one of starting a virtual processor associated with the guest partition or stopping the virtual processor.

3. The method of claim 1, wherein initiating the management operation includes stopping or restarting the guest OS, including setting an Advanced Configuration and Power Interface (ACPI) state.

4. The method of claim 1, wherein initiating the management operation includes presenting the serial console associated with the guest OS.

5. The method of claim 1, wherein initiating the management operation includes presenting the graphical console associated with the guest OS.

6. The method of claim 1, wherein initiating the management operation includes updating the firmware associated with the guest partition, and wherein the firmware is one of:
the guest firmware;
a Basic Input Output System (BIOS) firmware used by the guest OS; or
a Unified Extensible Firmware Interface (UEFI) firmware used by the guest OS.

7. The method of claim 1, wherein initiating the management operation includes managing the virtual device presented by the first guest privilege context, and wherein the virtual device is one of:
a virtual network interface over which the communications channel is established;
a virtual console device over which the graphical or the serial console is presented; or
a hardware interface device presented to the second guest privilege context.

8. The method of claim 1, wherein establishing the communications channel between the first guest privilege context and the client device comprises establishing the communications channel between a virtual network interface created by the guest firmware and the client device.

9. The method of claim 1, wherein establishing the communications channel between the first guest privilege context and the client device comprises establishing the communications channel between the guest firmware and a proxy component operating at a host partition.

10. The method of claim 1, wherein establishing the communications channel between the first guest privilege context and the client device comprises negotiating an encryption protocol with the client device.

11. The method of claim 1, further comprising creating the first guest privilege context and the second guest privilege context based on one or more of second-level address translation or nested virtualization.

12. The method of claim 1, wherein the guest OS is unaware of the first guest privilege context.

13. The method of claim 1, wherein a memory region associated with the guest partition is inaccessible to a host OS.

14. A computer system, comprising:
a processing system; and
a computer storage media that stores computer-executable instructions that are executable by the processing system to at least:
create a first guest privilege context and a second guest privilege context of a guest partition operating as a VM based on one or more of second-level address translation or nested virtualization, the second guest privilege being restricted from accessing memory associated with the first guest privilege context and being configured to operate a guest operating system (OS);
operate a guest firmware within the first guest privilege context;
establish a communications channel between the first guest privilege context and a client device;
receive, over the communications channel, a request for performance of a management operation against the VM; and
based on the request, initiate the management operation, including at least one of:
change a power state of the VM;
stop or restart the guest OS;
present a serial console associated with the guest OS;
present a graphical console associated with the guest OS;
update a firmware associated with the guest partition; or
manage a virtual device presented by the first guest privilege context.

15. The computer system of claim 14, wherein initiating the management operation includes changing the power state of the VM.

16. The computer system of claim 14, wherein initiating the management operation includes stopping or restarting the guest OS.

17. The computer system of claim 14, wherein initiating the management operation includes presenting the serial console associated with the guest OS or presenting the graphical console associated with the guest OS.

18. The computer system of claim 14, wherein initiating the management operation includes updating the firmware associated with the guest partition.

19. The computer system of claim 14, wherein initiating the management operation includes managing the virtual device presented by the first guest privilege context.

20. A computer program product comprising a computer storage media that stores computer-executable instructions that are executable by a processing system to at least:
operate a guest firmware within a first guest privilege context of a guest partition operating as a VM, the guest partition also including a second guest privilege context that is restricted from accessing memory associated with the first guest privilege context, and that is configured to operate a guest operating system (OS), wherein the guest OS is unaware of the first guest privilege context and wherein a memory region associated with the guest partition is inaccessible to a host OS; and
at the guest firmware,
establish a communications channel between the first guest privilege context and a client device;
receive, over the communications channel, a request for performance of a management operation against the VM; and
based on the request, initiate the management operation, including at least one of:
change a power state of the VM;
stop or restart the guest OS;
present a serial console associated with the guest OS;
present a graphical console associated with the guest OS;
update a firmware associated with the guest partition; or
manage a virtual device presented by the first guest privilege context.
